(19) United States
(12) Patent Application Publication
(10) Pub. No.: US 2018/0174191 A1
(43) Pub. Date: Jun. 21, 2018

(54) METHOD, SYSTEM AND NON-TRANSITORY COMPUTER-READABLE RECORDING MEDIUM FOR PROVIDING SCHEDULE-RELATED ADVERTISEMENTS

(71) Applicant: Konolabs, Inc., Seoul (KR)

(72) Inventors: Yun Jeong Min, Seoul (KR); Jae Hoon Choi, Seoul (KR); Dong Hyeon Kim, Yongin-si (KR); Jin Hyuk Lee, Seongnam-si (KR)

(73) Assignee: Konolabs, Inc., Seoul (KR)

(21) Appl. No.: 15/846,554

(22) Filed: Dec. 19, 2017

(30) Foreign Application Priority Data
Dec. 19, 2016 (KR) 10-2016-0173499

(51) Int. Cl. G06Q 30/02; G06N 99/00

(52) U.S. Cl. CPC G06Q 30/0264; G06Q 30/0277; G06Q 50/01; G06N 99/005; G06Q 30/0272

(57) ABSTRACT

According to one aspect of the invention, there is provided a method for providing a schedule-related advertisement, comprising the steps of: predicting an event to be created in at least one target time slot in a schedule of a target user, with reference to context information; determining a target advertisement to be provided in relation to the at least one target time slot, with reference to information on attributes of the predicted event; and providing the target user with the target advertisement in a manner related to the at least one target time slot.

### FIELD OF THE INVENTION

The present invention relates to a method, system and non-transitory computer-readable recording medium for providing schedule-related advertisements.

### BACKGROUND

Recently, the developments in technologies related to the Internet, cloud computing, and mobile devices have introduced a variety of cloud-based schedule management services such as Google Calendar, Microsoft Outlook, and iCloud.

The conventional schedule management services provide a function that allows a user to manage his/her schedule in a unified manner, regardless of locations, times, devices, and the like. However, they still provide a basic function of simply creating, modifying, deleting, or sharing an event according to an explicit and specific input of the user.

Recently, the developments in technologies related to big data and artificial intelligence have introduced techniques for analyzing life patterns or work patterns of a user to provide various predictions on the user's schedule (e.g., a technique for recommending an appropriate time for a new event to be added to the schedule, or recommending an appropriate event for a specific time in the schedule).

In this regard, the inventor(s) suggest a technique for effectively providing advertisements expected to be beneficial to a user, on the basis of various predictions on the user's schedule.

### SUMMARY OF THE INVENTION

One object of the present invention is to solve all the above-described problems in the prior art.

Another object of the invention is to provide a user with an advertisement according to a prediction on a specific time period in the user's schedule, by predicting an event to be created in at least one target time slot in a schedule of a target user, with reference to context information; determining a target advertisement to be provided in relation to the at least one target time slot, with reference to information on attributes of the predicted event; and providing the target user with the target advertisement in a manner related to the at least one target time slot.

The representative configurations of the invention to achieve the above objects are described below.

According to one aspect of the invention, there is provided a method for providing a schedule-related advertisement, comprising the steps of: predicting an event to be created in at least one target time slot in a schedule of a target user, with reference to context information;

determining a target advertisement to be provided in relation to the at least one target time slot, with reference to information on attributes of the predicted event; and providing the target user with the target advertisement in a manner related to the at least one target time slot.

According to another aspect of the invention, there is provided a system for providing a schedule-related advertisement, comprising: a schedule management unit configured to predict an event to be created in at least one target time slot in a schedule of a target user, with reference to context information; and an advertisement management unit configured to determine a target advertisement to be provided in relation to the at least one target time slot, with reference to information on attributes of the predicted event, and to provide the target user with the target advertisement in a manner related to the at least one target time slot.

In addition, there are further provided other methods and systems to implement the invention, as well as non-transitory computer-readable recording media having stored thereon computer programs for executing the methods.

According to the invention, it is possible to provide a user with an advertisement according to a prediction on the user's schedule, thereby dramatically increasing the effect (or performance) of the advertisement while providing the advertisement beneficial to the user.

According to the invention, it is possible to provide a user with an advertisement according to a prediction on the user's schedule in a manner that is temporally, spatially, or visually related to a specific time period for which the prediction is made, thereby reducing the user's possible aversion to the advertisement and allowing the user to beneficially utilize the advertisement.

According to the invention, it is possible to accurately (or specifically) estimate a performance of an advertisement for a user on the basis of an accuracy of a prediction on the user's schedule, thereby reasonably calculating an advertisement cost applied to an advertisement to be provided to the user in relation to the schedule, and providing an advertiser who makes a bid for an auction of the advertisement to be provided in relation to the schedule with accurate (or specific) estimation information on the performance of the advertisement, so that the advertiser may make a reasonable decision.

### BRIEF DESCRIPTION OF THE DRAWINGS

FIG. 1 schematically shows the configuration of an entire system for providing a schedule-related advertisement according to one embodiment of the invention.

FIG. 2 illustratively shows the internal configuration of a service provision system according to one embodiment of the invention.

FIG. 3 illustratively shows a situation in which a schedule-related advertisement is provided according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

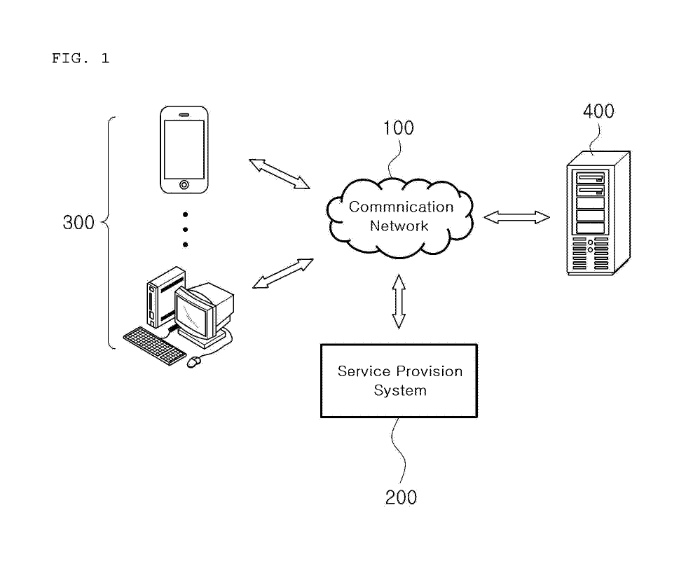

Configuration of the Entire System FIG. 1 schematically shows the configuration of an entire system for providing a schedule-related advertisement according to one embodiment of the invention.

As shown in FIG. 1, the entire system according to one embodiment of the invention may comprise a communication network 100, a service provision system 200, a user device 300, and an external server 400.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

Next, the service provision system 200 according to one embodiment of the invention may function to provide a user with an advertisement according to a prediction on a specific time period in the user's schedule, by predicting an event to be created in at least one target time slot in a schedule of a target user, with reference to context information; determining a target advertisement to be provided in relation to the at least one target time slot, with reference to information on attributes of the predicted event; and providing the target user with the target advertisement in a manner related to the at least one target time slot.

Meanwhile, although the service provision system 200 has been described as above, the above description is illustrative, and it will be apparent to those skilled in the art that at least a part of the functions or components required for the service provision system 200 may be implemented or included in the user device 300 or the external server 400, as necessary.

The configuration and function of the service provision system 200 according to the invention will be discussed in more detail below.

Next, according to one embodiment of the invention, the user device 300 is digital equipment that may function to allow a user to connect to and then communicate with the service provision system 200 or the external server 400, and any type of digital equipment having a memory means and a microprocessor for computing capabilities, such as a smart phone, a tablet, a desktop computer, a notebook computer, a workstation, a personal digital assistant (PDA), a web pad, and a mobile phone, may be adopted as the user device 300 according to the invention.

Particularly, the user device 300 may include an application (not shown) to assist a user to receive services for schedule management from the service provision system 200. The application may be downloaded from the service provision system 200 or the external server 400.

Meanwhile, according to one embodiment of the invention, the external server 400 may function to provide the service provision system 200 or the user device 300 with various context information required for making a prediction on the schedule, or various information on an advertisement to be provided in relation to the schedule. For example, the external server 400 according to one embodiment of the invention may be a server operated by an entity providing an online calendar service, or providing a social network service (SNS) such as Twitter, Facebook, and Instagram from which various context information or preference information on the user may be collected. As another example, the external server 400 according to one embodiment of the invention may be a server operated by an entity providing an advertisement agency service.

Configuration of the Service Provision System

Hereinafter, the internal configuration of the service provision system 200 crucial for implementing the invention and the functions of the respective components thereof will be discussed.

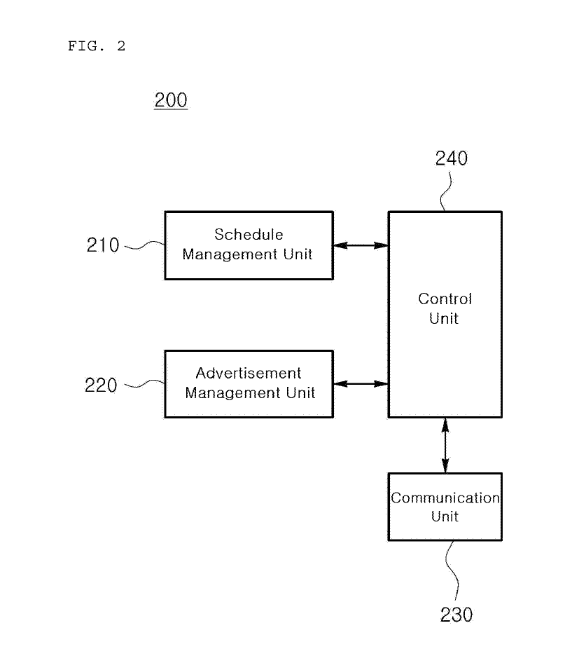

FIG. 2 illustratively shows the internal configuration of the service provision system according to one embodiment of the invention.

Referring to FIG. 2, the service provision system 200 according to one embodiment of the invention may comprise a schedule management unit 210, an advertisement management unit 220, a communication unit 230, and a control unit 240. According to one embodiment of the invention, at least some of the schedule management unit 210, the advertisement management unit 220, the communication unit 230, and the control unit 240 may be program modules to communicate with an external system (not shown). The program modules may be included in the service provision system 200 in the form of operating systems, application program modules, and other program modules, while they may be physically stored in a variety of commonly known storage devices. Further, the program modules may also be stored in a remote storage device that may communicate with the service provision system 200. Meanwhile, such program modules may include, but not limited to, routines, subroutines, programs, objects, components, data structures and the like for performing specific tasks or executing specific abstract data types as will be described below in accordance with the invention.

First, according to one embodiment of the invention, the schedule management unit 210 may function to predict an event to be created in at least one target time slot in a schedule of a target user, with reference to context information.

Here, according to one embodiment of the invention, the context information that is referred to in making the prediction may include information on a result of machine learning for at least one event existing in a schedule of at least one user including the target user; information on a current or past location of the target user; demographic information of the target user; information on the target user's activities on a social network service (SNS); information on memos created by the target user; information on chats that the target user has had with another user; and information on the target user's preference for the schedule. However, it is noted that the context information, which may be referred to in predicting an event to be created in at least one target time slot in the target user's schedule in the invention, is not necessarily limited thereto, and any other information may be referred to as long as the objects of the invention may be achieved.

Specifically, according to one embodiment of the invention, the schedule management unit 210 may calculate a likelihood (or an accuracy of prediction) of a specific event being created in a specific target time slot in the user's schedule, with reference to the various context information mentioned as above.

Meanwhile, various machine learning algorithms using artificial intelligence may be assumed to be the prediction algorithm that may be employed in the invention to predict what event is to be created in a target time slot in the user's schedule. However, it is noted that the prediction algorithm is not necessarily limited thereto, and any other type of algorithm may be employed as long as the objects of the invention may be achieved.

Next, according to one embodiment of the invention, the advertisement management unit 220 may function to determine a target advertisement to be provided in relation to the at least one target time slot in the user's schedule, with reference to information on attributes of the event that is predicted to be created in the corresponding target time slot.

Specifically, according to one embodiment of the invention, the advertisement management unit 220 may retrieve an advertisement content related to the attributes of the predicted event from advertisement contents that may be provided in real time from the external server 400 or an advertiser device (not shown) as well as those stored in the service provision system 200, and may determine the retrieved advertisement content as a target advertisement content to be provided in relation to the corresponding target time slot. Here, it should be understood that the retrieval is not limited only to retrieval in a traditional sense, i.e., finding out information directly matching the attributes of the predicted event, but encompasses, in its broadest sense, extracting or collecting an advertisement content that does not directly match the attributes of the predicted event but has a significant relationship therewith.

For example, when it is predicted that a user A will have a dinner with his/her partner in Gangnam-gu, Seoul from 7:00 pm to 9:00 pm on Dec. 24, 2016, an advertisement content a on an Italian restaurant located in Gangnam-gu, Seoul may be determined as a target advertisement content to be provided in relation to a target time slot from 7:00 pm to 9:00 pm on Dec. 24, 2016 in the schedule of the user A.

Further, according to one embodiment of the invention, the advertisement management unit 220 may function to provide the target user with the target advertisement determined as above, in a manner related to the corresponding target time slot.

Specifically, according to one embodiment of the invention, the advertisement management unit 220 may provide the target user with the determined target advertisement at a time temporally close to the corresponding target time slot. For example, the advertisement content a, which is to be provided in relation to the target time slot from 7:00 pm to 9:00 pm on Dec. 24, 2016 in the schedule of the user A, may be provided to the user A at any time from one week to one day before 7:00 pm on Dec. 24, 2016.

Further, according to one embodiment of the invention, the advertisement management unit 220 may provide the target user with the determined target advertisement in a location spatially close to a location of the event that is predicted to be created in the corresponding target time slot. For example, when a location of a dinner event predicted to be created in the time slot from 7:00 pm to 9:00 pm on Dec. 24, 2016 in the schedule of the user A is in Gangnam-gu, Seoul, the target advertisement content a may be provided to the user A while the user A is located in Gangnam-gu, Seoul or provided with other contents (e.g., dramas, SNS posts, or news) related to Gangnam-gu, Seoul.

Further, according to one embodiment of the invention, the advertisement management unit 220 may provide the determined target advertisement in an area visually close to the corresponding target time slot in a calendar GUI (Graphic User Interface) that visualizes the schedule of the target user. For example, when the advertisement content a is determined as the target advertisement content to be provided in relation to the target time slot from 7:00 pm to 9:00 pm on Dec. 24, 2016 in the schedule of the user A, the advertisement content a may be displayed where the target time slot from 7:00 pm to 9:00 pm on Dec. 24, 2016 is displayed in the calendar GUI that visualizes the schedule of the user A, or may be displayed in an area adjacent thereto.

Meanwhile, according to one embodiment of the invention, as the schedule management unit 210 predicts the event to be created in the at least one target time slot in the schedule of the target user, the advertisement management unit 220 may function to estimate a performance of the target advertisement to be provided in relation to the corresponding target time slot, on the basis of information on the prediction. Here, according to one embodiment of the invention, the information on the prediction based on which the performance of the target advertisement may be estimated may include an accuracy of the prediction. For example, as a likelihood of a specific event being created in a specific target time slot in the schedule of the target user is predicted to be higher, the advertisement management unit 220 according to one embodiment of the invention may estimate that a performance of a target advertisement to be provided in relation to the corresponding target time slot is higher.

Specifically, according to one embodiment of the invention, the advertisement management unit 220 may function to adaptively determine an advertisement cost applied to the target advertisement, on the basis of the estimated performance of the target advertisement. For example, as a likelihood of a specific event being created in a specific target time slot in the schedule of the target user is predicted to be higher, the advertisement management unit 220 according to one embodiment of the invention may determine an advertisement cost applied to a target advertisement to be provided in relation to the corresponding target time slot to be higher.

Further, according to one embodiment of the invention, the advertisement management unit 220 may provide information on the estimated performance of the target advertisement to a device (not shown) of an advertiser who makes a bid for an auction of the target advertisement, to assist the advertiser to make a reasonable decision on the auction of the target advertisement as the advertiser specifically recognizes a result of the estimation of the performance of the target advertisement.

Meanwhile, the communication unit 230 according to one embodiment of the invention may function to enable the service provision system 200 to communicate with an external device such as the user device 300, the external server 400, or the advertiser device (not shown).

Lastly, the control unit 240 according to one embodiment of the invention may function to control data flow among the schedule management unit 210, the advertisement management unit 220, and the communication unit 230. That is, the control unit 240 may control inbound data flow or data flow among the respective components of the service provision system 200, such that the schedule management unit 210, the advertisement management unit 220, and the communication unit 230 may carry out their particular functions, respectively.

### Embodiments

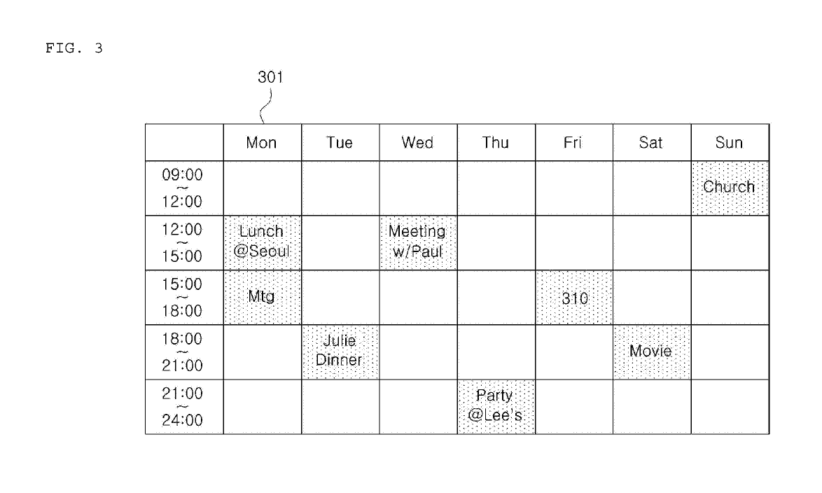

Hereinafter, the configuration for providing a schedule-related advertisement according to one embodiment of the invention will be discussed in detail with reference to FIG. 3.

FIG. 3 illustratively shows a situation in which a schedule-related advertisement is provided according to one embodiment of the invention.

Referring to FIG. 3, it may be assumed that a target advertisement related to a target time slot 310 from 15:00 to 18:00 on Friday, which exists in a calendar 301 of a user B, is provided.

In the embodiment of FIG. 3, the service provision system 200 according to one embodiment of the invention may predict an event (e.g., business meeting) whose likelihood (i.e., accuracy of prediction) of being created in the target time slot 310 is not less than 20%, and may determine an advertisement content b closely related to the predicted event (e.g., an advertisement content for promoting a service commercially providing meeting spaces) as a target advertisement to be provided in relation to the target time slot 310. Further, the service provision system 200 according to one embodiment of the invention may display the determined advertisement content b in an area corresponding to the target time slot 310 in the calendar 301 of the user B, or in an area corresponding to a preceding time slot close to the target time slot 310.

Further, in the embodiment of FIG. 3, the service provision system 200 according to one embodiment of the invention may adaptively determine an advertisement cost of the target advertisement provided in relation to the target time slot 310 in the calendar 301 of the user B, on the basis of the accuracy of the event prediction for the target time slot 310. For example, an advertisement cost applied to a first target advertisement, which is determined to be provided in relation to the target time slot 310 as it is closely related to a first event whose likelihood of being created in the target time slot 310 is predicted to be 50%, may be determined to be higher than an advertisement cost applied to a second target advertisement, which is determined to be provided in relation to the target time slot 310 as it is closely related to a second event whose likelihood of being created in the target time slot 310 is predicted to be 20%.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing a schedule-related advertisement, comprising the steps of:
predicting an event to be created in at least one target time slot in a schedule of a target user, with reference to context information;
determining a target advertisement to be provided in relation to the at least one target time slot, with reference to information on attributes of the predicted event; and
providing the target user with the target advertisement in a manner related to the at least one target time slot.

2. The method of claim 1, wherein the context information includes at least one of information on a result of machine learning for at least one event existing in a schedule of at least one user including the target user; information on a current or past location of the target user; demographic information of the target user; information on the target user's activities on a social network service (SNS); information on memos created by the target user; information on chats that the target user has had with another user; and information on the target user's preference for the schedule.

3. The method of claim 1, wherein in the providing step, the target advertisement is provided to the target user at a time temporally close to the at least one target time slot.

4. The method of claim 1, wherein in the providing step, the target advertisement is provided to the target user when the target user is located in a place spatially close to a location of the predicted event.

5. The method of claim 1, wherein in the providing step, the target advertisement is provided in an area visually close to the at least one target time slot in a calendar GUI (Graphic User Interface) that visualizes the schedule of the target user.

6. The method of claim 1, further comprising the step of:
estimating a performance of the target advertisement on the basis of an accuracy of the prediction.

7. The method of claim 6, wherein in the estimating step, an advertisement cost applied to the target advertisement is adaptively determined on the basis of the estimated performance of the target advertisement.

8. A non-transitory computer-readable recording medium having stored thereon a computer program for executing the method of claim 1.

9. A system for providing a schedule-related advertisement, comprising:
a schedule management unit configured to predict an event to be created in at least one target time slot in a schedule of a target user, with reference to context information; and
an advertisement management unit configured to determine a target advertisement to be provided in relation to the at least one target time slot, with reference to information on attributes of the predicted event, and to provide the target user with the target advertisement in a manner related to the at least one target time slot.

10. The system of claim 9, wherein the context information includes at least one of information on a result of machine learning for at least one event existing in a schedule of at least one user including the target user; information on a current or past location of the target user; demographic information of the target user; information on the target user's activities on a social network service (SNS); information on memos created by the target user; information on chats that the target user has had with another user; and information on the target user's preference for the schedule.

11. The system of claim 9, wherein the advertisement management unit provides the target user with the target advertisement at a time temporally close to the at least one target time slot.

12. The system of claim 9, wherein the advertisement management unit provides the target user with the target advertisement when the target user is located in a place spatially close to a location of the predicted event.

13. The system of claim 9, wherein the advertisement management unit provides the target advertisement in an area visually close to the at least one target time slot in a calendar GUI (Graphic User Interface) that visualizes the schedule of the target user.

14. The system of claim 9, wherein the advertisement management unit estimates a performance of the target advertisement on the basis of an accuracy of the prediction.

15. The system of claim 14, wherein the advertisement management unit adaptively determines an advertisement cost applied to the target advertisement, on the basis of the estimated performance of the target advertisement.
